(19) United States
(12) Patent Application Publication
(10) Pub. No.: US 2026/0100019 A1
(43) Pub. Date: Apr. 9, 2026

(54) Method for Recognition and Positioning of Micro-Operation Objects Under Deflection and Occlusion

(71) Applicant: Harbin University of Science and Technology, Harbin City (CN)

(72) Inventors: Dongjie LI, Harbin City (CN); Fuyue ZHANG, Harbin City (CN); Yu LIANG, Harbin City (CN); Yu ZHANG, Harbin City (CN); Liu YANG, Harbin City (CN); Donghao XU, Harbin City (CN); Xueying WANG, Harbin City (CN)

(73) Assignee: Harbin University of Science and Technology, Harbin City, HL (CN)

(21) Appl. No.: 19/415,607

(22) Filed: Dec. 10, 2025

(30) Foreign Application Priority Data
Dec. 19, 2024 (CN) CN202411880746.6

(51) Int. Cl. G06V 10/75; G02B 21/36; G06T 5/70

(52) U.S. Cl. CPC G06V 10/757; G02B 21/365; G06T 5/70

(57) ABSTRACT

A method for recognition and positioning of micro-operation objects under deflection and occlusion belongs to the technical field of micro-operation object recognition and positioning under microscopic vision. The present invention solves the problem of low positioning accuracy of micro-operation objects by existing methods when the micro-operation objects are deflected or occluded. The specific steps of the present invention are as follows: perform grayscale conversion and denoising processing on the original image where the micro-operation object is located to obtain a denoised image; perform wavelet decomposition on the denoised image to obtain a down sampled image; extract feature points from the down sampled image and the micro operation object template image respectively, and describe the feature points; match the feature points in the down sampled image and the micro-operation object template image to obtain coarsely matched feature point pairs, then screen the coarsely matched feature point pairs to obtain finely matched feature point pairs; obtain the coordinates of the operation point of the micro-operation object in the original image according to the fine matching result. The method of the present invention can be applied to the recognition and positioning of micro-operation objects.

### TECHNICAL FIELD

The present invention belongs to the technical field of micro-operation object recognition and positioning under microscopic vision, and specifically relates to a method for recognition and positioning of micro-operation objects under deflection and occlusion.

### BACKGROUND A

With the increasing complexity of micro-operation tasks, the requirements for the accuracy and precision of micro-operations are getting higher and higher, and simple manual operations can hardly meet the needs of the operation process. With the development of target detection and positioning technology based on image processing and microscopic vision control theory, the automation level of micro-operations has been greatly improved. In the picking and placing of micro-operations, the recognition and positioning of the end of the probe and the operation object are the prerequisites for realizing the contact picking and placing of micro-operations. The deflection and occlusion of micro-operation objects will have a significant impact on the recognition and positioning of micro-operation objects, seriously reducing the recognition accuracy and positioning precision of micro-operation objects.

Target recognition and positioning based on microscopic vision are mainly realized through different types of recognition technologies. The main methods include feature-based matching, grayscale-based template matching and deep learning-based methods. The feature-based target recognition algorithm realizes recognition through features such as lines, points, shapes and textures in image sequences with known geometric information, and has many studies and applications in microscopic vision target recognition and positioning. For the feature point-based matching method, the efficiency of feature point extraction and the accuracy of matching point screening directly affect the matching result. Therefore, domestic and foreign researchers have made improvements in improving efficiency and accuracy. When the recognized micro-operation object is occluded or the background interference is large, feature-based matching often fails to achieve accurate recognition and positioning. The grayscale-based template matching method operates directly on pixel values, does not require any form of specific target pattern, and has strong robustness to image noise due to the involvement of highly redundant information, so it is widely used in micro-vision target recognition and positioning. However, the high computational cost of the grayscale-based template matching method limits its application in microscopic target recognition and positioning. Therefore, many scholars have made improvements in the efficiency of template matching. Deep learning-based methods are widely used in the recognition of micro-operation objects. The application of deep learning algorithms in image target recognition requires a large number of datasets, but it is difficult to construct datasets for specific micro-operation objects. In addition, deep learning algorithms are generally used for qualitative recognition and classification in the micro-scale range, and have low precision in specific positioning.

To sum up, although domestic and foreign scholars have carried out a lot of research on the recognition and positioning of micro-operation objects, the existing microscopic vision target positioning and recognition algorithms still have the problem of low positioning precision of micro-operation objects when the micro-operation objects are deflected or occluded. Therefore, researching a high-precision and high-robustness algorithm for recognition and positioning of micro-operation objects is of great significance for realizing the automation of micro-operations.

### SUMMARY

The purpose of the present invention is to solve the problem of low positioning precision of micro-operation objects by existing methods when the micro-operation objects are deflected or occluded, and thus propose a method for recognition and positioning of micro-operation objects under deflection and occlusion.

The technical solution adopted by the present invention to solve the above technical problems is: a method for recognition and positioning of a micro-operation object under deflection and occlusion, which specifically comprises the following steps:
Step 1: Perform grayscale conversion on the original image where the micro-operation object is located to obtain a grayscale image, and then perform denoising processing on the grayscale image to obtain a denoised image;
Step 2: Initialize the number of wavelet decomposition times as n=1, perform the 1st wavelet decomposition on the denoised image to obtain a down sampled image after the 1st wavelet decomposition;
Step 3: Let n=n+1, perform the nth wavelet decomposition on the down sampled image after the (n−1)th wavelet decomposition to obtain a down sampled image after the nth wavelet decomposition;
Step 4: Determine whether n=N is satisfied, where N is the maximum number of wavelet decomposition times;
If n=N is satisfied, perform Step 5 on the down sampled image after the Nth wavelet decomposition;
If n=N is not satisfied, return to Step 3;
Step 5: Use the BRISK algorithm to extract feature points from the down sampled image after the Nth wavelet decomposition and the micro-operation object template image respectively, and then use the SURF algorithm to describe the feature points in the down sampled image after the Nth wavelet decomposition and the micro-operation object template image;
Step 6: According to the feature point description results in Step 5, use the Brute Force
matching algorithm to match the feature points in the down sampled image after the Nth wavelet decomposition and the micro-operation object template image to obtain coarsely matched feature point pairs;
Then screen the coarsely matched feature point pairs to eliminate mismatched feature point pairs from the coarsely matched feature point pairs, so as to obtain finely matched feature point pairs;
Step 7: Construct a homography matrix between the micro-operation object template image and the original image based on the finely matched feature point pairs, obtain the coordinates corresponding to the four vertices of the template image in the original image according to the coordinate information of the template image and the homography matrix, and calculate the coordinates of the operation point Peen-Cu of the micro-operation object according to the obtained coordinates.

### Beneficial Effects of the Present Invention

1. The improved bilateral filtering algorithm is used to remove high-frequency noise in the image while retaining high-frequency edge information in the image; an image pyramid is constructed through wavelet transform, and high-frequency information is added, which can retain and highlight the high-frequency information in the image while down sampling, making the extreme point features in the image more obvious.
2. The BRISK algorithm is used to extract feature points, and the SURF algorithm is used to describe the feature points. Compared with traditional algorithms, the present invention realizes efficient feature extraction while ensuring high matching precision
3. Compared with traditional algorithms, the feature point pair matching and screening algorithm of the present invention does not require iteration, which improves the efficiency of the algorithm. After screening the matching point pairs in the image, mismatched point pairs are completely eliminated, which ensures the precision of subsequent positioning. In addition, the screening method of the present invention improves the screening accuracy compared with existing methods.

Experimental results show that when the micro-operation object is occluded or deflected, the positioning error of traditional methods is greater than 5 pixels, and the time consumption is more than 400 ms, with low efficiency. The method of the present invention can realize accurate positioning when the micro-operation object is deflected or occluded, with a positioning error of less than 1 pixel and an average time consumption of about 98 ms. Compared with traditional methods, the method of the present invention has obvious advantages in both positioning precision and speed.

### DESCRIPTION OF DRAWINGS

FIG. 1 is a flowchart of a method for recognition and positioning of a micro-operation object under deflection and occlusion according to the present invention.

FIG. 2 is a flowchart of a matching point screening algorithm based on dimensional structural similarity.

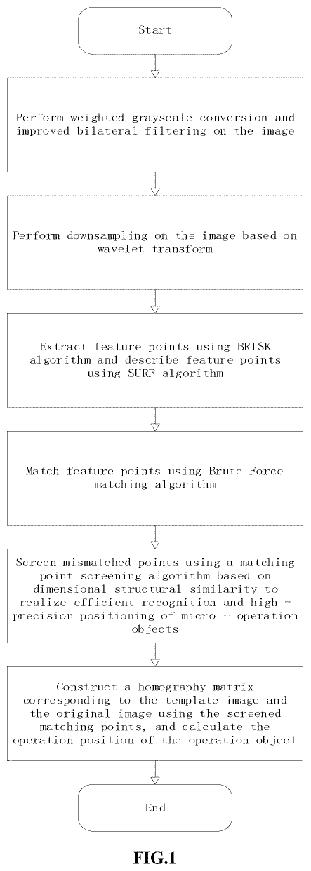

Specific Embodiment 1: This embodiment is described with reference to FIG. 1. The method for recognition and positioning of a micro-operation object under deflection and occlusion described in this embodiment is specifically as follows:
Step 1: Perform grayscale conversion on the original image where the micro-operation
Step 2: Initialize the number of wavelet decomposition times as n=1, perform the 1 st wavelet decomposition on the denoised image to obtain a down sampled image after the 1st wavelet decomposition;
Step 3: Let n=n+1, perform the nth wavelet decomposition on the down sampled image after the (n−1)th wavelet decomposition to obtain a down sampled image after the nth wavelet decomposition;
Step 4: Determine whether n=N is satisfied, where N is the maximum number of wavelet
   decomposition times (which can be set according to actual conditions, and is set to 3 in the present invention);

If n=N is satisfied, perform Step 5 on the down sampled image after the Nth wavelet decomposition;

If n=N is not satisfied, return to Step 3;
Step 5: Use the BRISK algorithm to extract feature points from the down sampled image after the Nth wavelet decomposition and the micro-operation object template image respectively, and then use the SURF algorithm to describe the feature points in the down sampled image after the Nth wavelet decomposition and the micro-operation object template image;
Step 6: According to the feature point description results in Step 5, use the Brute Force (BF) matching algorithm to match the feature points in the down sampled image after the Nth wavelet decomposition and the micro-operation object template image to obtain coarsely matched feature point pairs;

Then screen the coarsely matched feature point pairs to eliminate mismatched feature point pairs from the coarsely matched feature point pairs, so as to obtain finely matched feature point pairs;
Step 7: Construct a homography matrix between the micro-operation object template image and the original image based on the finely matched feature point pairs, obtain the coordinates
   corresponding to the four vertices of the template image in the original image according to the coordinate information of the template image and the homography matrix, and calculate the coordinates of the operation point Pcen-Cu of the micro-operation object according to the
   obtained coordinates (i.e., the coordinates corresponding to the geometric center of the operation object in the template image in the original image).

Since the metal micro-component (as the operation object) in the image may have an angular offset relative to the template image, the feature point matching algorithm can use the feature information of the image feature points for matching. By obtaining the positional relationship between the template image and the feature points corresponding to the down sampled image after the Nth wavelet decomposition, the angular offset and relative position between the operation target in the original image and the target on the template image can be determined, thereby completing the positioning of the target object. Therefore, a template matching algorithm based on feature points is selected to recognize the operation object and position the operation point.

Common algorithms for feature point extraction and description include Scale Invariant Feature Transform (SIFT), Speeded Up Robust Features (SURF), and Binary Robust Invariant Scalable Key points (BRISK). Compared with SIFT, SURF optimizes the description algorithm, ensuring matching precision with fewer descriptive features and improving matching efficiency. The BRISK algorithm simplifies the feature extraction method and feature description steps, and has higher efficiency than the previous two algorithms. However, due to the simplified description algorithm, the similarity of descriptive features is high, resulting in poor matching precision.

To realize efficient and high-precision feature point matching, the present invention proposes a feature point matching algorithm combining BRISK and SURF, which uses the BRISK algorithm to extract feature points and the SURF algorithm to describe the feature points. By performing feature point matching on 50 micro-operation object images and comparing with other algorithms, the comparison results show that the algorithm proposed by the present invention realizes efficient feature extraction while ensuring high matching precision, and has obvious advantages compared with the original algorithms.

Specific Embodiment 2: The difference between this embodiment and Specific Embodiment 1 is that the grayscale conversion performed on the original image where the micro-operation object is located adopts a weighted average grayscale algorithm.

Other steps and parameters are the same as those in Specific Embodiment 1.

The implementation process of the weighted average grayscale algorithm is specifically as follows:

$$gray = {α}_{1} \cdot R + {α}_{2} \cdot G + {α}_{3} \cdot B$$

Wherein, R, G and B are the values of the pixel point in the red, green and blue color channels in the original image respectively; α1, α2 and α3 are weight coefficients; gray is the calculated grayscale value of the pixel;
Substitute the R, G and B values of each pixel point in the original image into the above formula respectively to obtain the grayscale value corresponding to each pixel point;
Specific Embodiment 3: The difference between this embodiment and Specific Embodiment 1 or 2 is that the denoising processing performed on the grayscale image adopts an improved bilateral filtering algorithm, and the improved bilateral filtering algorithm is specifically as follows:

$$gray = {α}_{1} \cdot R + {α}_{2} \cdot G + {α}_{3} \cdot B$$

Wherein, f(x, y) is the grayscale value of the pixel point (x, y) in the grayscale image; Bilateral (x0, y0) is the grayscale value of the pixel point (x0, y0) in the denoised image; M(x0, y0) is the set of pixel points in the convolution kernel (a 3×3 convolution kernel is used in the present invention) centered at the pixel point (x0, y0) in the grayscale image; ω(x, y) is the bilateral filtering weight function of the pixel point (x, y);

Among them, ωd(x,y) is the spatial domain weight coefficient of the pixel point (x, y), and ωs(x,y) is the grayscale domain weight coefficient of the pixel point (x, y);

$${ω}_{d} ( x , y ) = exp [ - \frac{{( x - {x}_{0} )}^{2} + {( y - {y}_{0} )}^{2}}{2 {σ}_{d}^{2}} ]$$

$${ω}_{s} ( x , y ) = exp [ - \frac{{log}_{k} ( \vert f ( x , y ) - f ( {x}_{0} , {y}_{0} ) \vert + 1 ) \cdot exp ( \vert f ( x , y ) - f ( {x}_{0} , {y}_{0} ) \vert )}{2 {σ}_{s}^{2}} ]$$

Wherein, σdis the standard deviation of the spatial domain (for each pixel point in the set M(x0, y0), calculate \sqrt{[(x−x0)²+(y−y0)²]}, then calculate the standard deviation of \sqrt{[(x−x0)²+(y−y0)²]} corresponding to all pixel points, and use the calculated standard deviation as the standard deviation of the spatial domain);-rs is the standard deviation of the grayscale domain (subtract the grayscale value of the pixel point (x, y) from the grayscale value of each pixel point in the set M(x0, y0) respectively, then calculate the standard deviation of all obtained differences); f(x0, y0) is the grayscale value of the pixel point (x0, y0) in the grayscale image; [⋅] denotes the calculation of absolute value; k is an intermediate variable.

Other steps and parameters are the same as those in Specific Embodiment 1 or 2.

The improved bilateral filtering algorithm adopted in the present invention can remove high-frequency noise in the image while retaining high-frequency edge information in the image.

Specific Embodiment 4: The difference between this embodiment and any one of Specific Embodiments 1 to 3 is that the calculation method of the intermediate variable k is as follows:

Establish the Robert operator ∇fx in the x-direction and the Robert operator ∇fy in the y-direction, which are respectively:

$$∇ {f}_{x} = [ \begin{matrix}- 1 & 0 \\ 0 & 1\end{matrix} ] , ∇ {f}_{y} = [ \begin{matrix}0 & - 1 \\ 1 & 0\end{matrix} ]$$

Use ∇fx and ∇fy to construct a gradient image of the grayscale image, then calculate the average grayscale value of all pixels in the gradient image, and use the calculated average grayscale value as k.

Other steps and parameters are the same as those in any one of Specific Embodiments 1 to 3.

Specific Embodiment 5: The difference between this embodiment and any one of Specific Embodiments 1 to 4 is that the step of performing the 1st wavelet decomposition on the denoised image to obtain a down sampled image after the 1st wavelet decomposition is specifically as follows:

Express the Haar wavelet decomposition convolution kernel H as:

Perform Haar wavelet decomposition on the denoised image based on H:

Wherein, HT denotes the transpose of H; G denotes the denoised image; Gw denotes the image after Haar wavelet decomposition; G11 denotes the low-frequency sub-image in Gw (the low-frequency sub-image contains the basic information in the image G); G12, G21 and G22 denote the high-frequency sub-images in Gw (the three sub-images all contain a certain degree of high-frequency information); and the sizes of G11, G12, G21 and G22 are all ¼ of that of G;
Add the three high-frequency sub-images G12, G21 and G22, perform normalization processing on the grayscale of each pixel point in the image obtained by the addition operation, and use the image obtained after normalization processing as the down sampled image after the 1st wavelet decomposition.

Other steps and parameters are the same as those in any one of Specific Embodiments 1 to 4.

The wavelet transform adopted in this embodiment can retain and highlight the high-frequency information in the image while down sampling, making the extreme point features in the image more obvious. The down sampling processing can solve the problem of low processing efficiency caused by the large number of pixels in the original image.

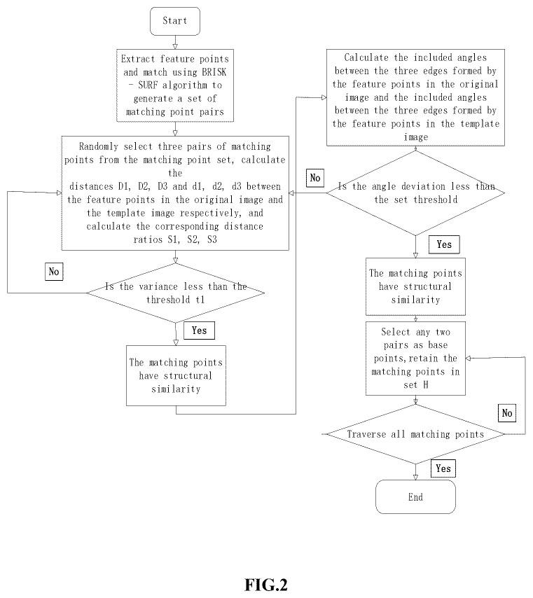

Specific Embodiment 6: This embodiment is described with reference to FIG. 2. The difference between this embodiment and any one of Specific Embodiments 1 to 5 is that the step of screening the coarsely matched feature point pairs to eliminate mismatched feature point pairs from the coarsely matched feature point pairs and obtain finely matched feature point pairs is specifically as follows:
Step 6-1: Denote the set of coarsely matched feature point pairs as set A, randomly select three pairs of feature point pairs (P1, p1), (P2, p2), (P3, p3) from set A, and eliminate the selected feature point pairs from set A;

Wherein, P1, P2 and P3 are feature points in the down sampled image after the Nth wavelet decomposition; p1, p2 and p3 are feature points in the micro-operation object template image;
Step 6-2: Denote the distance between feature point P1 and feature point P2 as D1, the distance between feature point P1 and feature point P3 as D2, the distance between feature point P2 and feature point P3 as D3, the distance between feature point p1 and feature point p2 as d1, the distance between feature point p1 and feature point p3 as d2, and the distance between feature point P2 and feature point P3 as d3;

Then calculate the intermediate variables S1, S2 and S3:
Step 6-3: Calculate the variance of S1, S2 and S3;

If the calculated variance is less than the set distance variance threshold t1, proceed to Step 6-4;

If the calculated variance is greater than or equal to the set threshold t1, randomly select a pair of feature point pairs from the remaining feature point pairs in set A, eliminate the selected feature point pairs from set A; replace any one pair of the three pairs of feature point pairs corresponding to the variance with the selected feature point pairs to obtain a group of feature point pairs consisting of three pairs of feature point pairs, and then return to Step 6-2 for the obtained group of feature point pairs;
Step 6-4: Calculate the included angle α1 between the line connecting feature point P1 and feature point P2 and the line connecting feature point P1 and feature point P3, the included angle α2 between the line connecting feature point P1 and feature point P2 and the line connecting feature point P2 and feature point P3, the included angle α3 between the line connecting feature point P1 and feature point P3 and the line connecting feature point P2 and feature point P3, the included angle β1 between the line connecting feature point p1 and feature point p2 and the line connecting feature point p1 and feature point p3, the included angle β2 between the line connecting feature point p1 and feature point p2 and the line connecting feature point p2 and feature point p3, and the included angle β3 between the line connecting feature point p1 and feature point p3 and the line connecting feature point p2 and feature point p3;

The calculation formula of the included angle between vectors is as follows:

$$α = arc cos ( \frac{{x}_{1} \times {x}_{2} + {y}_{1} \times {y}_{2}}{\sqrt{{( {x}_{1} - {x}_{2} )}^{2} + {( {y}_{1} - {y}_{2} )}^{2}}} )$$

Calculate the included angle deviations |α1−β1|, |α2−β2| and |α3−β3|;

If |α1−β1|, |α2−β2| and |α3−β3| are all less than the set angle variance threshold t2, then the three pairs of feature point pairs (P1, p1), (P2, p2), (P3, p3) are all correctly matched feature point pairs, and perform Step 6-5 on the three pairs of feature point pairs (P1, p1), (P2, p2), (P3, p3);

Otherwise, randomly select a pair of feature point pairs from the remaining feature point pairs in set A, eliminate the selected feature point pairs from set A; replace any one pair of the three pairs of feature point pairs (referring to the three pairs of feature point pairs participating in the current operation) with the selected feature point pairs to re-obtain a group of feature point pairs consisting of three pairs of feature point pairs, and then return to Step 6-2 for the obtained group of feature point pairs;
Step 6-5: Select any two pairs from the three pairs of feature point pairs as base points, and use the selected base points to verify each remaining feature point pair in set A in sequence. The verification method is as follows:

For any remaining feature point pair in set A, form a group of feature point pairs with the feature point pair and the base points; if the group of feature point pairs meets both the distance variance threshold condition and the angle variance threshold condition (i.e., the variance calculated based on the group of feature point pairs is less than t1, and the three included angle deviations corresponding to the group of feature point pairs are all less than t2), then the feature point pair is a correctly matched feature point pair; otherwise, the feature point pair is a mismatched feature point pair;

After verifying each remaining feature point pair in set A respectively, all correctly matched feature point pairs are obtained, that is, the finely matched feature point pairs are obtained.

Other steps and parameters are the same as those in any one of Specific Embodiments 1 to 5.

Specific Embodiment 7: The difference between this embodiment and any one of Specific Embodiments 1 to 6 is that the value of the distance variance threshold t1 is 0.04.

Other steps and parameters are the same as those in any one of Specific Embodiments 1 to 6.

Specific Embodiment 8: The difference between this embodiment and any one of Specific Embodiments 1 to 7 is that the value of the angle variance threshold t2 is 0.06.

Other steps and parameters are the same as those in any one of Specific Embodiments 1 to 7.

By setting appropriate distance variance threshold t1 and angle variance threshold t2, correct matching point pairs can be retained while all incorrect matching point pairs are filtered out, achieving the best screening effect. In addition, compared with traditional algorithms, the matching point pair screening algorithm of the present invention does not require iteration, which improves the efficiency of the algorithm. After screening the matching point pairs in the image, mismatched point pairs are completely eliminated, improving the screening accuracy.

Specific Embodiment 9: The difference between this embodiment and any one of Specific Embodiments 1 to 8 is that the step of calculating the coordinates of the operation point P_{cen-Cu} of the micro-operation object according to the obtained coordinates is specifically as follows:

$${P}_{cen - Cu - x} = \frac{{P}_{1 - x}^{′} + {P}_{2 - x}^{′} + {P}_{3 - x}^{′} + {P}_{4 - x}^{′}}{4}$$

$${P}_{cen - Cu - y} = \frac{{P}_{1 - y}^{′} + {P}_{2 - y}^{′} + {P}_{3 - y}^{′} + {P}_{4 - y}^{′}}{4}$$

Wherein, P_{cen-Cux} is the abscissa of the operation point P_{cen-Cu}; P_{cen-Cu-y} is the ordinate of the operation point Pcen-Cu; P′₁₋ₓ, P′₂₋ₓ, P′₃₋ₓ and P′₄₋ₓ are the abscissas corresponding to the four vertices of the template image in the original image; P′_{1-y}, P′_{2-y}, P′_{3-y} and P′_{4-y} are the ordinates corresponding to the four vertices of the template image in the original image.

Other steps and parameters are the same as those in any one of Specific Embodiments 1 to 8.

### EXAMPLE

This example proposes a method for recognition and positioning of a micro-operation object under deflection and occlusion, which is specifically as follows:
Step 1: Perform grayscale conversion on the original image where the micro-operation object is located by using a weighted average grayscale algorithm to obtain a grayscale image, and then perform denoising processing on the grayscale image by using an improved bilateral filtering algorithm to obtain a denoised image;

The improved bilateral filtering algorithm is specifically as follows:

$${f}_{Bilateral} ( {x}_{0} , {y}_{0} ) = \frac{{\sum }_{( x , y ) ∈ M ( {x}_{0} , {y}_{0} )} ω ( x , y ) f ( x , y )}{{\sum }_{( x , y ) ∈ M ( {x}_{0} , {y}_{0} )} ω ( x , y )} ω ( x , y )$$

Wherein, f(x, y) is the grayscale value of the pixel point (x, y) in the grayscale image; fBilateral (x0, y0) is the grayscale value of the pixel point (x0, y0) in the denoised image; M(x0, y0) is the set of pixel points in the convolution kernel (a 3×3 convolution kernel is used in the present invention) centered at the pixel point (x0, y0) in the grayscale image; ω(x, y) is the bilateral filtering weight function of the pixel point (x, y);

Among them, od(x, y) is the spatial domain weight coefficient of the pixel point (x, y), and ωs(x, y) is the grayscale domain weight coefficient of the pixel point (x, y);

Wherein, ad is the standard deviation of the spatial domain (for each pixel point in the set M(x0, y0), calculate √[(x−x0)²+(y−y0)²], then calculate the standard deviation of √(x−x0)²+(y−y0)²] corresponding to all pixel points, and use the calculated standard deviation as the standard deviation of the spatial domain); as is the standard deviation of the grayscale domain (subtract the grayscale value of the pixel point (x, y) from the grayscale value of each pixel point in the set M(x0, y0) respectively, then calculate the standard deviation of all obtained differences); f(x0, y0) is the grayscale value of the pixel point (x0, y0) in the grayscale image; |⋅| denotes the calculation of absolute value; k is an intermediate variable.

The calculation method of the intermediate variable k is as follows:

Establish the Robert operator ∇fx in the x-direction and the Robert operator ∇fy in the y-direction, which are respectively:

Use ∇fx and ∇fy to construct a gradient image of the grayscale image, then calculate the average grayscale value of all pixels in the gradient image, and use the calculated average grayscale value as k.
Step 2: Initialize the number of wavelet decomposition times as n=1, perform the 1st wavelet decomposition on the denoised image to obtain a down sampled image after the 1st wavelet decomposition; specifically as follows:

Express the Haar wavelet decomposition convolution kernel H as:

Perform Haar wavelet decomposition on the denoised image based on H:

$${G}_{w} = {H}^{T} GH = [ \begin{matrix}{G}_{11} & {G}_{12} \\ {G}_{21} & {G}_{22}\end{matrix} ]$$

Wherein, HT denotes the transpose of H; G denotes the denoised image; Gw denotes the image after Haar wavelet decomposition; G11 denotes the low-frequency sub-image in Gw (the low-frequency sub-image contains the basic information in the image G); G12, G21 and G22 denote the high-frequency sub-images in Gw (the three sub-images all contain a certain degree of high-frequency information); and the sizes of G11, G12, G21 and G22 are all ¼ of that of G;

Add the three high-frequency sub-images G12, G21 and G22, perform normalization processing on the grayscale of each pixel points in the image obtained by the addition operation, and use the image obtained after normalization processing as the down sampled image after the 1st wavelet decomposition.
Step 3: Let n=n+1, perform the nth wavelet decomposition on the down sampled image after the (n-1)th wavelet decomposition to obtain a down sampled image after the nth wavelet decomposition;
Step 4: Determine whether n=N is satisfied, where N is the maximum number of wavelet decomposition times (which can be set according to actual conditions, and is set to 3 in the present invention);

If n=N is satisfied, perform Step 5 on the down sampled image after the Nth wavelet decomposition;

If n=N is not satisfied, return to Step 3;
Step 5: Use the BRISK algorithm to extract feature points from the down sampled image after the Nth wavelet decomposition and the micro-operation object template image respectively, and then use the SURF algorithm to describe the feature points in the down sampled image after the Nth wavelet decomposition and the micro-operation object template image;
Step 6: According to the feature point description results in Step 5, use the Brute Force (BF) matching algorithm to match the feature points in the down sampled image after the Nth wavelet decomposition and the micro-operation object template image to obtain coarsely matched feature point pairs;

Then screen the coarsely matched feature point pairs to eliminate mismatched feature point pairs from the coarsely matched feature point pairs, so as to obtain finely matched feature point pairs; specifically as follows:
Step 6-1: Denote the set of coarsely matched feature point pairs as set A, randomly select three pairs of feature point pairs (P1, p1), (P2, p2), (P3, p3) from set A, and eliminate the selected feature point pairs from set A;

Wherein, P1, P2 and P3 are feature points in the down sampled image after the Nth wavelet decomposition; p1, p2 and p3 are feature points in the micro-operation object template image;
Step 6-2: Denote the distance between feature point P1 and feature point P2 as D1, the distance between feature point P1 and feature point P3 as D2, the distance between feature point P2 and feature point P3 as D3, the distance between feature point p1 and feature point p2 as d1, the distance between feature point p1 and feature point p3 as d2, and the distance between feature point P2 and feature point P3 as d3;

Then calculate the intermediate variables Si, S2 and S3:
Step 6-3: Calculate the variance of S1, S2 and S3;

If the calculated variance is less than the set distance variance threshold t1 (in the present invention, the value of t1 is 0.04), proceed to Step 6-4;

If the calculated variance is greater than or equal to the set threshold t1, randomly select a pair of feature point pairs from the remaining feature point pairs in set A, eliminate the selected feature point pairs from set A; replace any one pair of the three pairs of feature point pairs corresponding to the variance with the selected feature point pairs to obtain a group of feature point pairs consisting of three pairs of feature point pairs, and then return to Step 6-2 for the obtained group of feature point pairs;
Step 6-4: Calculate the included angle α1 between the line connecting feature point P1 and feature point P2 and the line connecting feature point P1 and feature point P3, the included angle α2 between the line connecting feature point P1 and feature point P2 and the line connecting feature point P2 and feature point P3, the included angle α3 between the line connecting feature point P1 and feature point P3 and the line connecting feature point P2 and feature point P3, the included angle β1 between the line connecting feature point p1 and feature point p2 and the line connecting feature point p1 and feature point p3, the included angle β2 between the line connecting feature point p1 and feature point p2 and the line connecting feature point p2 and feature point p3, and the included angle β3 between the line connecting feature point p1 and feature point p3 and the line connecting feature point p2 and feature point p3;

The calculation formula of the included angle between vectors is as follows:

$$α = arc cos ( \frac{( {x}_{1} {x}_{2} - {y}_{1} {y}_{2} )}{√ [ {( {x}_{1} - {x}_{2} )}^{2} + {( {y}_{1} {y}_{2} )}^{2} ]} )$$

Calculate the included angle deviations |α1−β1|, |α2−β2| and |α3−β3|;

If |α1−β1|, |α2−β2| and |α3−β3| are all less than the set angle variance threshold t2 (in the present invention, the value of t2 is 0.06), then the three pairs of feature point pairs (P1, p1), (P2, p2), (P3, p3) are all correctly matched feature point pairs, and perform Step 6-5 on the three pairs of feature point pairs (P1, p1), (P2, p2), (P3, p3);

Otherwise, randomly select a pair of feature point pairs from the remaining feature point pairs in set A, eliminate the selected feature point pairs from set A; replace any one pair of the three pairs of feature point pairs (referring to the three pairs of feature point pairs participating in the current operation) with the selected feature point pairs to re-obtain a group of feature point pairs consisting of three pairs of feature point pairs, and then return to Step 6-2 for the obtained group of feature point pairs;
Step 6-5: Select any two pairs from the three pairs of feature point pairs as base points, and use the selected base points to verify each remaining feature point pair in set A in sequence. The verification method is as follows:

For any remaining feature point pair in set A, form a group of feature point pairs with the feature point pair and the base points; if the group of feature point pairs meets both the distance variance threshold condition and the angle variance threshold condition (i.e., the variance calculated based on the group of feature point pairs is less than t1, and the three included angle deviations corresponding to the group of feature point pairs are all less than t2), then the feature point pair is a correctly matched feature point pair; otherwise, the feature point pair is a mismatched feature point pair;

After verifying each remaining feature point pair in set A respectively, all correctly matched feature point pairs are obtained, that is, the finely matched feature point pairs are obtained.
Step 7: Construct a homography matrix between the micro-operation object template image and the original image based on the finely matched feature point pairs, obtain the coordinates corresponding to the four vertices of the template image in the original image according to the coordinate information of the template image and the homography matrix, and calculate the coordinates of the operation point P_{cen-Cu} of the micro-operation object according to the obtained coordinates (i.e., the coordinates corresponding to the geometric center of the operation object in the template image in the original image):

$${P}_{cen - Cu -} x = \frac{{P}_{1 - x}^{′} + {P}_{2 - x}^{′} + {P}_{3 - x}^{′} + {P}_{4 - x}^{′}}{4}$$

$${P}_{cen - Cu -} y = \frac{{P}_{1 - y}^{′} + {P}_{2 - y}^{′} + {P}_{3 - y}^{′} + {P}_{4 - y}^{′}}{4}$$

Wherein, P_{cen-Cu-x} is the abscissa of the operation point P_{cen-Cu}; P_{cen-Cu-y} is the ordinate of the operation point P_{cen-Cu}; P₁₋ₓ, P₂₋ₓ, P′₃₋ₓ and P′₄₋ₓ are the abscissas corresponding to the four vertices of the template image in the original image; P′_{1-y}, P′_{2-y}, P′_{3-y} and P′_{4-y} are the ordinates corresponding to the four vertices of the template image in the original image.

The above calculation example of the present invention only explains the calculation model and calculation process of the present invention in detail, and is not intended to limit the implementation of the present invention. For those of ordinary skill in the art, on the basis of the above description, other changes or modifications in different forms can also be made. It is impossible to enumerate all implementation manners here. All obvious changes or modifications derived from the technical solution of the present invention still fall within the protection scope of the present invention.

What is claimed is:

1. A method for recognition and positioning of a micro—operation object under deflection and occlusion
Step 1: Performing grayscale conversion on the original image where the micro—operation object is located to obtain a grayscale image, and then performing denoising processing on the grayscale image to obtain a denoised image;
Step 2: Initializing the number of wavelet decomposition times as n=1,and performing the 1st wavelet decomposition on the denoised image to obtain a down sampled image after the 1st wavelet decomposition;
Step 3: performing nth wavelet decomposition on the down sampled image, where n=n+1, and after the (n−1)th wavelet decomposition to obtain a down sampled image after the nth wavelet decomposition;
Step 4: Judging whether n=N is satisfied, where N is the maximum number of wavelet decomposition times; If n=N is satisfied, perform Step 5 on the down sampled image after the Nth wavelet decom position; If n=N is not satisfied, return to Step 3;
Step 5: Using the BRISK algorithm to respectively extract feature points from the down sampled image after the Nth wavelet decomposition and the micro—operation object template image, and then use the SURF algorithm to describe the feature points in the down sampled image after the Nth wavelet decomposition and the micro—operation object template image;
Step 6: According to the feature point description results in Step 5, use the Brute Force matching algorithm to match the feature points in the down sampled image after the Nth wavelet decomposition and the micro—operation object template image to obtain coarsely matched feature point pairs; Then screen the coarsely matched feature point pairs to eliminate the mismatched feature point pairs from the coarsely matched feature point pairs, so as to obtain finely matched feature point pairs;
Step 7: Constructing a homography matrix between the micro—operation object template image and the original image based on the finely matched feature point pairs, obtain the coordinates corresponding to the four vertices of the template image in the original image according to the coordinate information of the template image and the homography matrix, and calculate the coordinates of the operation point P_{cen-Cu} of the micro—operation object according to the obtained coordinates.

2. The method for recognition and positioning of a micro—operation object under deflection and occlusion according to claim 1, which is characterized in that the weighted average grayscale algorithm is adopted for the grayscale conversion of the original image where the micro—operation object is located.

3. The method for recognition and positioning of a micro—operation object under deflection and occlusion according to claim 2, which is characterized in that the improved bilateral filtering algorithm is adopted for the denoising processing of the grayscale image, and the improved bilateral filtering algorithm is specifically as follows: herein, (fx,y) is the grayscale value of the pixel point (x,y) in the grayscale image; f_{Bilateral}(x₀,y₀) is the grayscale value of the pixel point (x₀,y₀) in the denoised image; M(x₀,y₀) is the set of pixel points in the convolution kernel centered on the pixel point (x,y) in the grayscale image; ω(x,y) is the bilateral filtering weight function of the pixel point (x,y); Among them, ω_{d}(x,y) is the spatial domain weight coefficient of the pixel point (x,y) and ωₛ(x,y) is the grayscale domain weight coefficient of the pixel point (x,y);
$$( {ω}_{d} ( x , y ) = exp ⌈ - \frac{{( x - {x}_{0} )}^{2} + {( y - {y}_{0} )}^{2}}{2 {σ}_{d}^{2}} ⌉ )$$
$$( {ω}_{s} ( x , y ) = exp ⌈ - \frac{\begin{matrix}{log}_{k} ( \vert f ( x , y ) - f ( x - {x}_{0} ) \vert + 1 ) \cdot \\ exp ( \vert f ( x , y ) - f ( {x}_{0} , {y}_{0} ) \vert )\end{matrix}}{2 {σ}_{s}^{2}} ⌉ )$$
Wherein, σd is the standard deviation of the spatial domain; σs is the standard deviation of the grayscale domain; f(x0, y0) is the grayscale value of the pixel point (x0,y0) in the grayscale image; |⋅| denotes the calculation of absolute value; k is an intermediate variable.

4. The method for recognition and positioning of a micro-operation object under deflection and occlusion according to claim 3, characterized in that the calculation method of the intermediate variable k is as follow:
Establishing the Robert operator ∇fx in the x-direction and the Robert operator ∇fy in the y-direction, which are respectively:
$$∇ {f}_{x} = [ \begin{matrix}- 1 & 0 \\ 0 & 1\end{matrix} ]$$
$$∇ {f}_{y} = [ \begin{matrix}0 & - 1 \\ 1 & 0\end{matrix} ]$$
Using ∇fx and ∇fy to construct a gradient image of the grayscale image, then calculate the average grayscale value of all pixels in the gradient image, and use the calculated average grayscale value ask.

5. The method for recognition and positioning of a micro-operation object under deflection and occlusion according to claim 4, characterized in that the step of performing the 1st wavelet decomposition on the denoised image to obtain a down sampled image after the 1st wavelet decomposition is specifically as follows:
Express the Haar wavelet decomposition convolution kernel H as:
$$H = \frac{1}{\sqrt{2}} [ \begin{matrix}1 & 2 \\ 1 & - 1\end{matrix} ]$$
Performing Haar wavelet decomposition on the denoised image based on H:
$$Gw = {H}^{T} GH = [ \begin{matrix}G 11 & G 12 \\ G 21 & G 22\end{matrix} ]$$
Wherein, HT denotes the transpose of H; G denotes the denoised image; Gw denotes the image after Haar wavelet decomposition; G11 denotes the low-frequency sub-image in Gw; G12, G21 and G22 denote the high-frequency sub-images in Gw;
Add the three high-frequency sub-images G12, G2 and G22, perform normalization processing on the grayscale of each pixel point in the image obtained by the addition operation, and use the image obtained after normalization processing as the down sampled image after the 1st wavelet decomposition.

6. The method for recognition and positioning of a micro-operation object under deflection and occlusion according to claim 5, characterized in that the step of screening the coarsely matched feature point pairs to eliminate mismatched feature point pairs from the coarsely matched feature point pairs and obtain finely matched feature point pairs is specifically as follows:
Step 6-1: Denoting the set of coarsely matched feature point pairs as set A, randomly select three pairs of feature point pairs (P1,p1), (P2,p2), (P3,p3) from set A, and eliminate the selected feature point pairs from set A; Wherein, P1,P2 and P3 are feature points in the down sampled image after the Nth wavelet decomposition; p1,p2 and p3 are feature points in the micro-operation object template image;
Step 6-2: Denoting the distance between feature point P1 and feature point P2 as D1, the distance between feature point P1 and feature point P3 as D2, the distance between feature point P2 and feature point P3 as D3, the distance between feature point p1 and feature point p2 as d1, the
distance between feature point p1 and feature point p3 as d2, and the distance between feature point P2 and feature point P3 as d3;
Then calculate the intermediate variables S1, S2 and S3:
$$( {s}_{1} = \frac{{d}_{1}}{{D}_{1}} ) ( {s}_{2} = \frac{{d}_{2}}{{D}_{2}} ) ( {s}_{3} = \frac{{d}_{3}}{{D}_{3}} )$$
Step 6-3: Calculating the variance of S1, S2 and S3If the calculated variance is less than the set distance variance threshold t1, proceed to Step 6-4;
If the calculated variance is greater than or equal to the set threshold t1, randomly select a pair of feature point pairs from the remaining feature point pairs in set A, eliminate the selected feature point pairs from set A; replace any one pair of the three pairs of feature point pairs corresponding to the variance with the selected feature point pairs to obtain a group of feature point pairs consisting of three pairs of feature point pairs, and then return to Step 6-2 for the obtained group of feature point pairs;
Step 6-4: Calculating the included angle α1 between the line connecting feature point P1 and feature point P2 and the line connecting feature point P1 and feature point P3, the included angle α2 between the line connecting feature point P1 and feature point P2 and the line connecting feature point P2 and feature point P3, the included angle α3 between the line connecting feature point P 1 and feature point P3 and the line connecting feature point P2 and feature point P3, the included angle β1 between the line connecting feature point p1 and feature point p2 and the line connecting feature point p1 and feature point p3, the included angle β2 between the line connecting feature point p1 and feature point p2 and the line connecting feature point p2 and feature point p3, and the included angle β3 between the line connecting feature point p1 and feature point p3 and the line connecting feature point p2 and feature point p3; Calculate the included angle deviations |α1−β|, |α2−β2| and |α3−β3|; If |α1−β1|, |α2−β2| and |α3−β3| are all less than the set angle variance threshold t2, then the three pairs of feature point pairs (P1, p1), (P2, p2), (P3, p3) are all correctly matched feature point pairs, and perform Step 6-5 on the three pairs of feature point pairs (P1, p1), (P2, p2), (P3, p3);
Otherwise, randomly select a pair of feature point pairs from the remaining feature point pairs in set A, eliminate the selected feature point pairs from set A; replace any one pair of the three pairs of feature point pairs (referring to the three pairs of feature point pairs participating in the current operation) with the selected feature point pairs to re-obtain a group of feature point pairs consisting of three pairs of feature point pairs, and then return to Step 6-2 for the obtained group of feature point pairs;
Step 6-5: Select any two pairs from the three pairs of feature point pairs as base points, and use the selected base points to verify each remaining feature point pair in set A in sequence. The verification method is as follows:
For any remaining feature point pair in set A, form a group of feature point pairs with the feature point pair and the base points; if the group of feature point pairs meets both the distance variance threshold condition and the angle variance threshold condition (i.e., the variance calculated based on the group of feature point pairs is less than t1, and the three included angle deviations corresponding to the group of feature point pairs are all less than t2), then the feature point pair is a correctly matched feature point pair; otherwise, the feature point pair is a mismatched feature point pair;
After verifying each remaining feature point pair in set A respectively, all correctly matched feature point pairs are obtained, that is, the finely matched feature point pairs are obtained.

7. The method for recognition and positioning of a micro-operation object under deflection and occlusion according to claim 6, characterized in that the value of the distance variance threshold t 1 is 0.04.

8. The method for recognition and positioning of a micro-operation object under deflection and occlusion according to claim 7, characterized in that the value of the angle variance threshold t2 is 0.06.

9. The method for recognition and positioning of a micro-operation object under deflection and occlusion according to claim 8, characterized in that the step of calculating the coordinates of the operation point P_{cen-Cu} of the micro-operation object according to the obtained coordinates is specifically as follows:
$${P}_{cen - Cu - x} = \frac{{P}_{1}^{′} - x + {P}_{2}^{′} - x + {P}_{3}^{′} - x + {P}_{4}^{′} - x}{4}$$
$${P}_{cen - Cu - y} = \frac{{P}_{1}^{′} - y + {P}_{2}^{′} - y + {P}_{3}^{′} - y + {P}_{4}^{′} - y}{4}$$
Wherein, P_{cen-Cu-x} is the abscissa of the operation point P_{cen-Cu}; P_{cen-Cu-y} is the ordinate of the operation point P_{cen-Cu}; P′₁₋ₓ, P′₂₋ₓ, P′₃₋ₓ and P′₄₋ₓ are the abscissas corresponding to the four vertices of the template image in the original image; P′_{1-y}, P′_{2-y}, P′_{3-y} and P′_{4-y} are the ordinates corresponding to the four vertices of the template image in the original image.
